(19) United States
(12) Patent Application Publication
(10) Pub. No.: US 2023/0079969 A1
(43) Pub. Date: Mar. 16, 2023

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Masaaki Kobayashi, Tokyo (JP)

(21) Appl. No.: 17/929,615

(22) Filed: Sep. 2, 2022

(30) Foreign Application Priority Data
Sep. 14, 2021 (JP) 2021-149348

(51) Int. Cl. G06F 3/01; G06T 7/223; G06F 3/16; G10L 17/22; G10L 25/51

(52) U.S. Cl. CPC G06F 3/011; G06T 7/223; G06F 3/167; G06F 3/017; G10L 17/22; G10L 25/51; G06T 2207/30196

(57) ABSTRACT

An information processing apparatus includes a motion analysis unit configured to analyze a motion of an object in a moving image, a sound identification unit configured to identify detected sound by analyzing the detected sound while playing the moving image, and a control unit configured to perform processing corresponding to a combination of motion information including an analysis result of the motion of the object and sound identification information including an identification result of the sound.

### BACKGROUND

### Field

The present disclosure relates to an information processing apparatus, an information processing method, and a storage medium.

### Description of the Related Art

Conventional information processing apparatuses are typically operated by using an input device including a physical switch, such as a keyboard, a mouse, and a stick controller. In contrast, in recent years, an operation method that does not use such a physical switch, such as operation using gesture recognition from a captured image and operation using voice recognition has been put to practical use.

In particular, a head-mounted display (HMD)-type extended reality (XR) information processing terminal has become widespread in recent years. The XR is a general term for virtual reality (VR), augmented reality (AR), and mixed reality (MR). In a case of using the HMD-type XR information processing terminal, a user often holds a controller with the hand to perform operation. However, depending on an application, it may be inconvenient or difficult for the user to perform operation while holding the controller with the hand in some cases. On the other hand, along with the improvement in calculation capacity of the information processing apparatus and an object detection technique, it is becoming possible to operate the information processing terminal by performing the gesture recognition from the captured image and the like in real time without using the controller. “MediaPipe Hands: On-device Real-time Hand Tracking”, Fan Zhang, Valentin Bazarevsky, Andrey Vakunov, Andrei Tkachenka, George Sung, Chuo-Ling Chang, Matthias Grundmann, CVPR Workshop on Computer Vision for Augmented and Virtual Reality, Seattle, Wash., USA, 2020 discusses an example of a technique in which fingers and the motions of the fingers (gesture operation) are recognized, and a result of the recognition is applied to the operation of an information processing terminal.

On the other hand, under the condition where the motion of an object such as a hand and fingers is recognized as a gesture, and a result of the recognition is used for the operation of an information processing terminal, the motion of an object that is not intended by the user may be erroneously recognized as a gesture, and an erroneous operation may be induced.

### SUMMARY

According to an aspect of the present disclosure, an information processing apparatus includes a motion analysis unit configured to analyze a motion of an object in a moving image, a sound identification unit configured to identify detected sound by analyzing the detected sound while playing the moving image, and a control unit configured to perform processing corresponding to a combination of motion information including an analysis result of the motion of the object and sound identification information including an identification result of the sound.

Further features of the present disclosure will become apparent from the following description of exemplary embodiments with reference to the attached drawings.

### BRIEF DESCRIPTION OF THE DRAWINGS

FIGS. 1A and 1B are diagrams each illustrating a configuration of an information processing apparatus according to a first exemplary embodiment.

FIG. 2 is a flowchart illustrating an example of processing performed by the information processing apparatus according to the first exemplary embodiment.

FIG. 3 is a diagram illustrating examples of operation corresponding to a combination of image information and sound identification information according to the first exemplary embodiment.

FIG. 4 is a diagram illustrating examples of a marker code according to the first exemplary embodiment.

FIG. 5 is a diagram illustrating examples of operation corresponding to a combination of the image information and the sound identification information according to the first exemplary embodiment.

FIG. 6 is a flowchart illustrating an example of processing performed by an information processing apparatus according to a second exemplary embodiment.

FIG. 7 is a diagram illustrating examples of operation corresponding to a combination of the image information and the sound identification information according to the second exemplary embodiment.

FIG. 8 is a flowchart illustrating an example of processing performed by an information processing apparatus according to a third exemplary embodiment.

FIG. 9 is a flowchart illustrating an example of processing performed by an information processing apparatus according to a fourth exemplary embodiment.

FIG. 10 is a diagram illustrating examples of operation corresponding to a combination of the image information and the sound identification information according to the fourth exemplary embodiment.

FIG. 11 is a flowchart illustrating an example of processing performed by an information processing apparatus according to a fifth exemplary embodiment.

FIG. 12 is a diagram illustrating examples of operation corresponding to a combination of the image information and the sound identification information according to the fifth exemplary embodiment.

FIG. 13 is a diagram illustrating an example of a method relating to detection of objects from an image.

FIG. 14 is a diagram illustrating an example of a system modal window.

### DESCRIPTION OF THE EMBODIMENTS

Some exemplary embodiments of the present disclosure are described in detail below with reference to accompanying drawings.

In the present specification and the drawings, components having substantially the same functional configuration are denoted by the same reference numerals, and repetitive descriptions are omitted.

As a first exemplary embodiment of the present disclosure, a description will be given of an example of a mechanism for realizing operation of an information processing apparatus using contact determination for determining whether a plurality of objects detected from a captured image is in contact with each other and an analysis result of sound such as voice uttered by a user.

In the present exemplary embodiment, for convenience, the information processing apparatus is a head-mounted display (HMD)-type extended reality (XR) information processing terminal, an application of a moving image player is executed on an operating system (OS) of the information processing terminal, and the user performs operation while viewing a moving image. Further, the HMD-type information processing terminal includes a display panel, a motion sensor, a camera module, a microphone, a communication module, a battery, and a system substrate in its housing. The camera module is supported by the housing of the HMD so as to image a direction in which a line of sight of the user is directed while the HMD is mounted on the user's head. In other words, in the present exemplary embodiment, the above-described camera module corresponds to an example of an “imaging apparatus” that captures an image in the direction in which the line of sight of the user is directed.

### Configuration

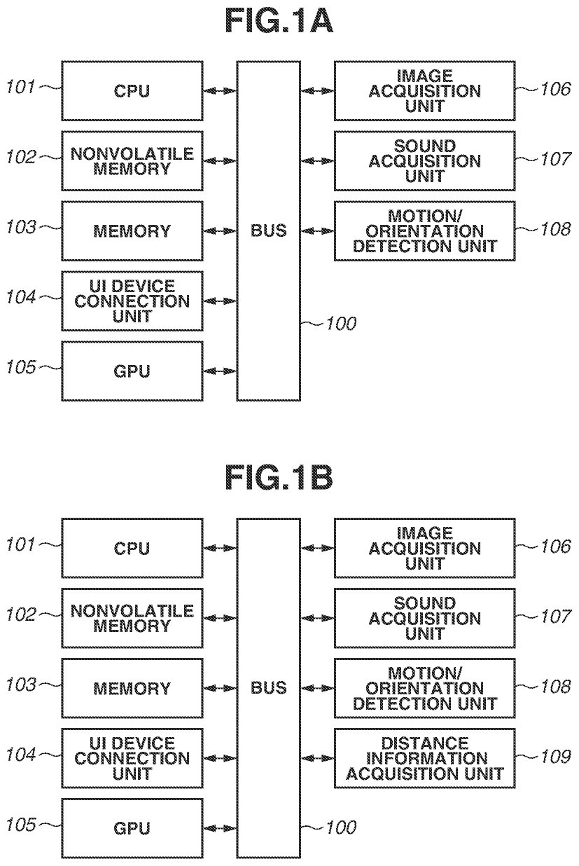

An example of a configuration of the information processing apparatus (HMD-type XR information processing terminal) according to the present exemplary embodiment is described with reference to FIG. 1A. A configuration illustrated in FIG. 1B is described below together with a description of a third exemplary embodiment.

The information processing apparatus according to the present exemplary embodiment includes a central processing unit (CPU) 101, a nonvolatile memory 102, a memory 103, a user interface (UI) device connection unit 104, and a graphics processing unit (GPU) 105. The information processing apparatus further includes an image acquisition unit 106, a sound acquisition unit 107, and a motion/orientation detection unit 108. The components included in the information processing apparatus are connected via a bus 100 so as to transmit and receive data to and from one another. In other words, the bus 100 manages a flow of data inside the information processing apparatus.

The CPU 101 executes built-in software to control operation of each of the components of the information processing apparatus.

The nonvolatile memory 102 is a storage area storing programs and data.

The memory 103 is a storage area temporarily storing programs and data. For example, the programs and the data stored in the nonvolatile memory 102 are loaded to the memory 103 on startup of the information processing apparatus. The memory 103 may also store data on an acquired image and data on a generated image. In addition, the memory 103 functions as a work area for the CPU 101.

The UI device connection unit 104 is an interface for connection of various kinds of devices in order to realize an UI. In the present exemplary embodiment, the UI device connection unit 104 receives input from a controller by wireless communication via a communication module.

The GPU 105 is a processor performing processing to generate various kinds of images such as computer graphics (CG). The GPU 105 transfers generated image data to an output apparatus such as a display panel and causes the output apparatus to display an image based on the image data.

The image acquisition unit 106 is connected to the camera module, and acquires digital image data (e.g., red-green-blue (RGB) image data) from the camera module. As described above, the camera module is supported by the housing of the information processing apparatus which is a HMD-type information processing terminal, and captures an image in the direction in which the line of sight of the user wearing the information processing apparatus is directed.

The sound acquisition unit 107 is connected to a sound collection device such as a microphone, and acquires data on digital sound (e.g., voice uttered by user and surrounding environment sound) corresponding to a result of sound collection by the sound collection device.

The motion/orientation detection unit 108 is connected to a sensor that detects the motion of the housing and a change in the orientation (inclination) of the housing of the information processing apparatus, such as a motion sensor, and detects the motion and a change in the orientation of the housing based on information output from the sensor. When the motion/orientation detection unit 108 detects the motion and a change in the orientation of the information processing apparatus in the above-described manner, the GPU 105 can render CG objects in synchronization with the motion of the user wearing the information processing apparatus, and an image obtained as a result of the rendering can be displayed on the display panel. As a result, for example, in a case where the direction in which the line of sight of the user is directed changes, it is possible to realize XR (e.g., virtual reality (VR), augmented reality (AR), and mixed reality (MR)) by controlling the appearance of a virtual object, such as CG, based on the direction in which the line of sight of the user is directed.

### Processing

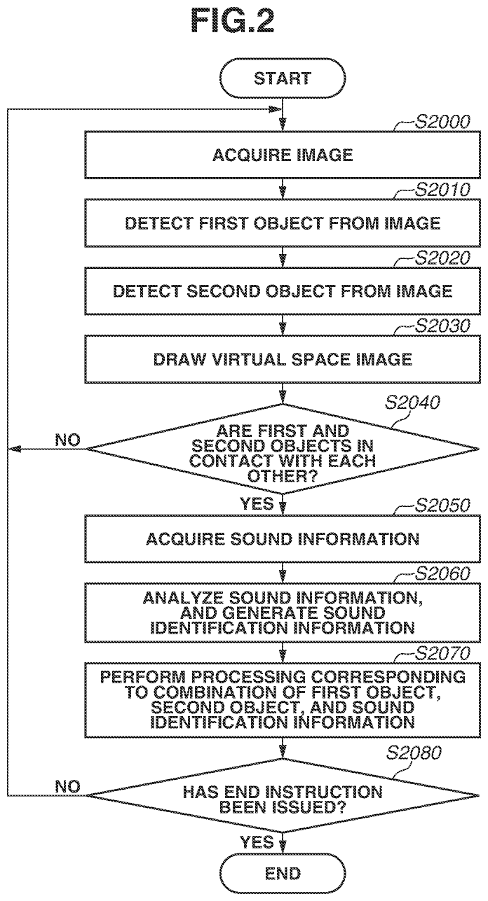

Next, an example of processing performed by the information processing apparatus according to the present exemplary embodiment is described with reference to FIG. 2 particularly focusing on operation for each frame relating to realization of operation of the information processing apparatus using contact determination for determining whether a plurality of objects is in contact with each other and an analysis result of sound such as voice uttered by the user.

In step S2000, the image acquisition unit 106 acquires data on an image corresponding to an imaging result of the camera module. As a specific example, the image acquisition unit 106 may acquire data on an image corresponding to the imaging result at a predetermined frame rate (e.g., at 1/60 seconds) from the camera module. The information processing apparatus suspends execution of next processing until acquisition of the data on the image from the camera module is completed. As a result, the processing is synchronized between the camera module and the information processing apparatus.

In step S2010, the GPU 105 detects a first object (i.e., identifies a first object) from the image of the data acquired in step S2000. In the present exemplary embodiment, the GPU 105 detects a first rectangular area indicating the right-hand finger of the user that is the first object, from the image of the acquired data.

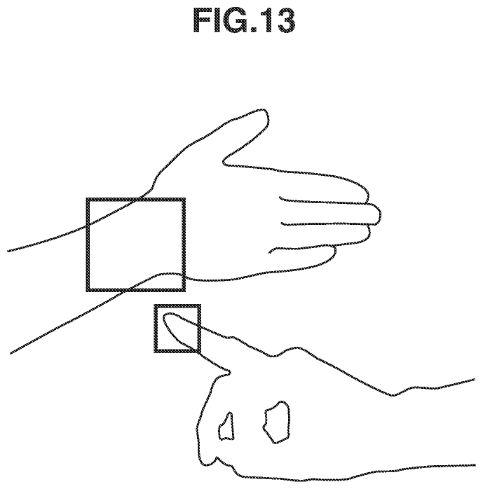

An example of a method relating to detection of objects from an image is described with reference to FIG. 13. In the example illustrated in FIG. 13, an example of a detection result of the right-hand finger and the left wrist by the image acquisition unit 106 is schematically illustrated. More specifically, in the example illustrated in FIG. 13, a position where the right-hand finger is detected is indicated by a rectangular area. Note that an existing technique is adoptable as a method of detecting an object captured in an image. Therefore, detailed description of the method is omitted.

In step S2020, the GPU 105 detects a second object (i.e., identifies a second object) from the image of the acquired data. In the present exemplary embodiment, the GPU 105 detects a second rectangular area indicating the left wrist of the user that is the second object, from the image of the acquired data. For example, in the example illustrated in FIG. 13, a position where the left wrist is detected is indicated by a rectangular area.

In step S2030, the GPU 105 draws a virtual space image (e.g., CG), and displays the drawn image on the display panel connected to the GPU 105. In the present exemplary embodiment, the GPU 105 draws the first object (the right-hand finger) detected in step S2010 and the second object (the left wrist) detected in step S2020 in the virtual space. As a result, for example, an image in which the detection results of the first object and the second object and the virtual space image are combined is drawn. The image of each of the first object and the second object drawn at this time may be an actually-captured image corresponding to the imaging result of the camera module, or may be a virtual image such as a CG model.

Further, the GPU 105 may superimpose other virtual objects over the first object or the second object as if the virtual objects are worn on the first object or the second object. As a specific example, the GPU 105 may superimpose a virtual object indicating a wristwatch device over the left-wrist that is the second object as if the wristwatch device is worn on the left wrist. Further, the GPU 105 may draw information indicating the detection results of the first object and the second object. For example, as in the example illustrated in FIG. 13, the GPU 105 draws the rectangular areas to indicate the position where the first object (the right-hand finger) is detected and the position where the second object (the left wrist) is detected.

In step S2040, the GPU 105 determines whether the first object and the second object are in contact with each other.

In a case where the GPU 105 determines in step S2040 that the first object and the second object are in contact with each other (YES in step S2040), the processing proceeds to step S2050.

In contrast, in a case where the GPU 105 determines in step S2040 that the first object and the second object are not in contact with each other (NO in step S2040), the processing returns to step S2000. In this case, the processing in and after step S2000 is performed again.

The contact between the first object and the second object may be determined based on, for example, whether the first rectangle and the second rectangle are overlapped with each other in the image.

In this case, if the first rectangle and the second rectangle are overlapped with each other in the image, it is determined that the first object and the second object are in contact with each other. Otherwise, it is determined that the first object and the second object are not in contact with each other.

In step S2050, the sound acquisition unit 107 acquires sound data (hereinafter, also referred to as “acoustic data”) corresponding to a collection result of sound around the information processing apparatus, as sound information. In the present exemplary embodiment, acoustic data for three seconds is constantly and continuously recorded in a ring buffer separately from the processing flow illustrated in FIG. 2, and the digital acoustic data for last three seconds is acquired at a timing when the processing in step S2050 is performed.

In step s2060, the CPU 101 identifies the collected sound by performing analysis processing (e.g., acoustic analysis processing and voice recognition processing) on the sound information acquired in step S2050, and generates sound identification information indicating an identification result of the sound. As a specific example, the CPU 101 may perform the voice recognition processing on a part corresponding to voice in the sound represented by digital acoustic data, to recognize an uttered word and generate sound identification information including a recognition result of the word. Further, at this time, the CPU 101 may identify a plurality of words that are synonyms in a series of uttered words so as to be handled as information indicating the same meaning, based on language analysis processing such as natural language processing. A sound identification method, a voice recognition method, and the like are not particularly limited, and an existing technique is adoptable. Therefore, detailed descriptions thereof are omitted.

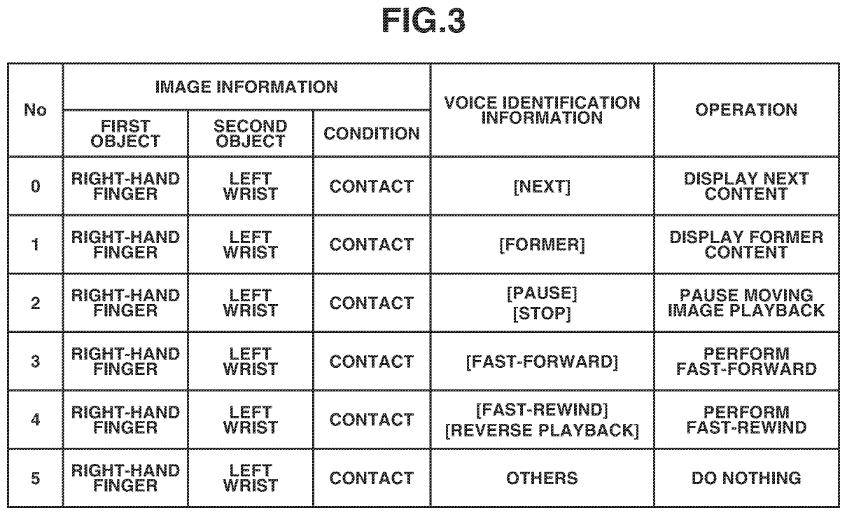

Further, in an example illustrated in FIG. 3, to facilitate understanding of characteristics of the technique according to the present exemplary embodiment, sound to be identified is voice, and voice identification information representing the identification result of the voice is generated as the sound identification information.

In step S2070, the CPU 101 performs processing corresponding to a combination of the information on the motion analysis results of the first object and the second object (e.g., a detection result of contact between the objects) and the sound identification information acquired in step S2060.

For example, FIG. 3 illustrates examples of processing performed corresponding to a combination of the information on the motion analysis results of the first object and the second object and the voice identification information, and the description particularly focuses on a case where a command for a moving image player is executed.

More specifically, in a column of “image information”, two objects to be detected (i.e., to be identified) from the captured image and a condition that is based on the motions of the two objects are defined. More specifically, in columns of “first object” and “second object”, two objects to be detected (the first object and the second object) from the captured image are defined. Further, in a column of “condition”, the motions of the objects to be detected is defined. In other words, in the example illustrated in FIG. 3, a detection result indicating that the “right-hand finger” and the “left wrist” detected from the captured image are in “contact” with each other is used as one of triggers to execute a command for the moving image player.

Further, in a column of “voice identification information”, uttered sounds used as the above-described voice identification information are defined. For example, in the example illustrated in FIG. 3, uttered words such as “next”, “former”, “pause”, “stop”, “fast-forward”, “fast-rewind”, and “reverse playback” are used as the voice identification information as one of the triggers to execute a command for the moving image player.

In a column of “operation”, commands (i.e., processing to be performed) for the moving image player that are associated with respective combinations of “image information” and “voice identification information” in advance are defined. These commands are executed by using a general method for moving image players, so that the detailed description thereof is omitted.

“Others” defined in the column of “voice identification information” corresponds to a sound that cannot be identified, a sound that is not to be used as the voice identification information, and the like. Further, “others” may include silence or no sound. In other words, even if contact between the right-hand finger and the left wrist is detected, no processing is performed as control for the operation of the moving image player in a case where the sound cannot be identified, a sound not to be used as the voice identification information is detected, or no sound has been detected.

Referring back to FIG. 2, in step S2080, the CPU 101 determines whether an end instruction has been issued. As a specific example, the CPU 101 may determine whether an “end command” has been performed in step S2070, and determine that the end instruction has been issued in a case where the “end command” has been performed.

In a case where the CPU 101 determines in step S2080 that the end instruction has not been issued (NO in step S2080), the processing returns to step S2000. In this case, the processing in and after step S2000 is performed again.

In contrast, in a case where the CPU 101 determines in step S2080 that the end instruction has been issued (YES in step S2080), the series of processing illustrated in FIG. 2 ends.

In the present exemplary embodiment, the image acquired by the camera module supported by the housing of the HMD is an image captured as a result of imaging in the direction in which the line of sight of the user wearing the HMD is directed.

Accordingly, the user can perform various kinds of operation while viewing an image closer to realistic operation.

In determination using an analysis result of an image like a gesture, a motion that is not intended by the user as operation may be erroneously recognized as a gesture, and erroneous operation may be induced by the erroneous recognition. In determination of a command by voice recognition, a word included in normal conversation may be recognized as a command for operation even though the user does not intend the operation, which may lead to erroneous operation.

In contrast, in the present exemplary embodiment, as described above, the determination relating to command execution is performed by combining the determination of the command by the voice recognition with the determination of the motions of the objects (e.g., determination of whether the objects are in contact with each other) using the analysis result of the image. As a result, a condition for starting a command is further restricted, which makes it possible to suppress occurrence of erroneous operation.

In particular, in the technique according to the present exemplary embodiment, the object contact determination is made with slight ambiguity. For example, it is only determined whether the objects overlap each other without determination of whether the objects are surely in contact with each other. As a result, an effect of suppressing occurrence of erroneous operation can be expected.

In the example described with reference to FIG. 2 and FIG. 3, the voice acquired while the target objects are in contact with each other is handled as an analysis target; however, operation of the information processing apparatus according to the present exemplary embodiment is not limited thereto. As a specific example, in a case where the objects are once detected to be in contact with each other and thereafter become separated from each other, then in the processing in step S2040, the objects may be determined to in contact with each other for a predetermined period (e.g., three seconds) after the separation. In this case, the contact between the objects may be recorded at the time when the contact between the objects is detected, and the contact determination may be made based on whether the objects come into contact with each other within the predetermined period.

Further, in the example described with reference to FIG. 2 and FIG. 3, the voice identification information is generated irrespective of candidate words in the analysis of the voice information (sound information); however, operation of the information processing apparatus according to the present exemplary embodiment is not limited thereto. As a specific example, in the analysis of the sound information, it may be determined whether the sound information can be converted into any of prescribed candidates (e.g., words exemplified as voice identification information in FIG. 3), and in a case where the sound information can be converted into any of the candidates, the voice identification information may be generated.

Further, in the example described with reference to FIG. 2 and FIG. 3, it is determined whether to execute the command based on the combination of the determination of the motions of the objects using the analysis result of the image and the determination of the command by voice recognition. Alternatively, it may be determined whether to execute the command based on additional information in combination with the above-described information. As a specific example, it may be determined whether to execute the command based on operation using a common controller in combination with the determination of the motions of the objects using the image analysis result and the determination of the command by the voice recognition.

Further, in the above-described example, the camera module, the microphone, and the display panel are incorporated in the information processing apparatus; however, the configuration of the information processing apparatus according to the present exemplary embodiment is not limited thereto. As a specific example, at least any of the camera module, the microphone, and the display panel may be realized as a device to be externally mounted on the information processing apparatus. The information processing apparatus according to the present exemplary embodiment may be configured as a device to realize AR by adopting a see-through display as the display panel. To realize AR, virtual information is superimposed on a real space. Therefore, processing relating to drawing of the virtual space may not be performed.

Further, in the present exemplary embodiment, a body part such as a left wrist and a right-hand finger is used as an object to be subjected to motion detection, e.g., contact detection; however, the object is not limited to the body parts, and other objects may be detected (identified).

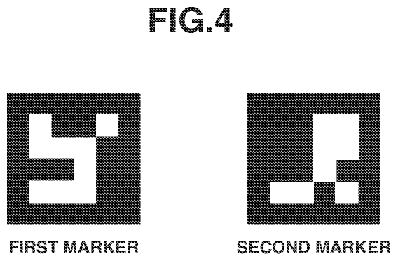

As a specific example, marker codes illustrated in FIG. 4 may be disposed in a real space, and it may be determined whether the right-hand finger come into contact with the marker code. A marker code is an image that is convertible into a code (e.g., numerical value) because of its unique shape.

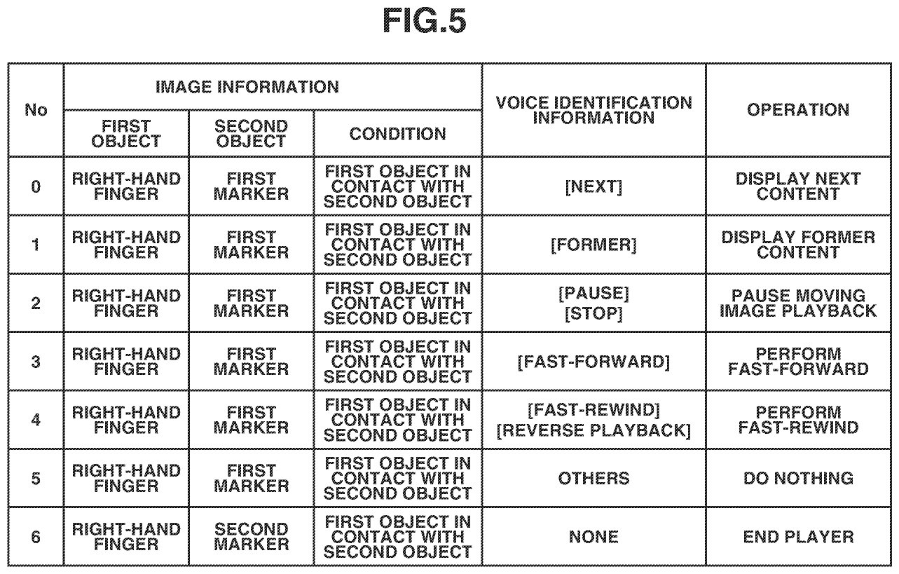

FIG. 5 illustrates other examples of the processing performed corresponding to the combination of the information on the analysis results of the motions of the first object and the second object and the voice identification information. In the example illustrated in FIG. 5, a first marker or a second marker is detected as the second object, the detected marker is converted into a code, and a marker detected based on the code is identified to be any of the first marker and the second marker. There are various methods of generating a marker code, and a method of generating a marker code is not particularly limited in the present exemplary embodiment. Further, in this case, a virtual space image in which a virtual object (e.g., a virtual button) is superimposed over the marker code disposed in a real space may be drawn in the processing in step S2030.

Further, in the above-described example, user identification is not mentioned in relation to the description of the voice recognition; however, in the voice recognition, the user may be identified by using, for example, an analysis result of the voice. In this case, for example, in a case where a voice of another user other than the target user is recognized, a detection result of the voice may be excluded from identification information to be used.

As a second exemplary embodiment of the present disclosure, an example case where the technique according to the present disclosure is applied to operation of a system in which an application is active is described. In the present exemplary embodiment, a configuration and operation are described focusing on differences from the above-described first exemplary embodiment, and detailed descriptions of parts substantially similar to the above-described first exemplary embodiment are omitted.

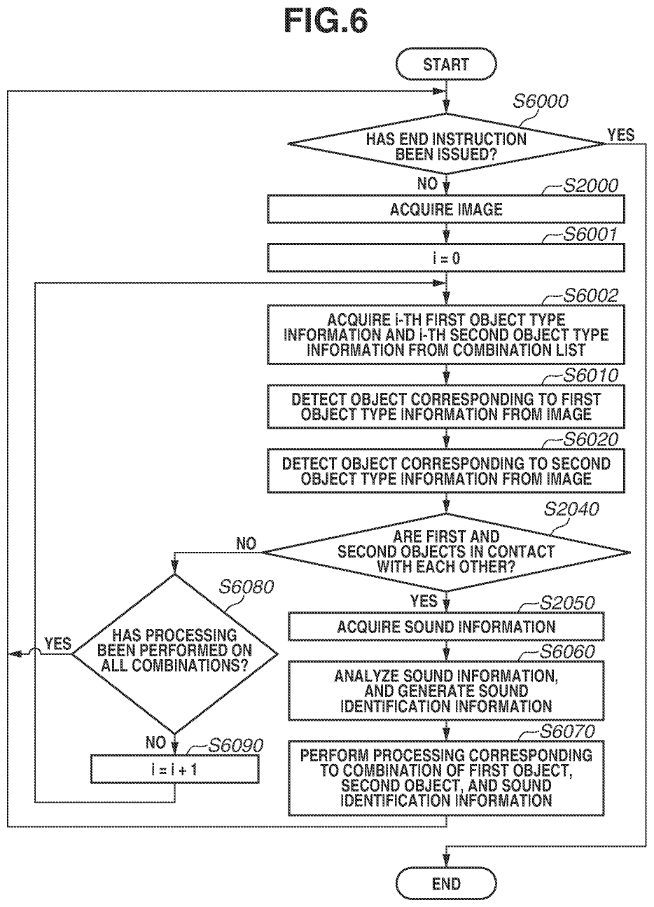

An example of processing performed by an information processing apparatus according to the present exemplary embodiment is described with reference to FIG. 6.

In step S6000, the CPU 101 determines whether an end instruction has been issued. As a specific example, in a case where an end instruction is issued in processing in step S6070 to be described below or in a case where an end signal is received from the outside, the CPU 101 may determine that the end instruction has been issued.

The end signal from the outside corresponds to, for example, a signal emitted in a case where a power button of the apparatus is depressed.

In a case where the CPU 101 determines in step S6000 that the end instruction has not been issued (NO in step S6000), the processing proceeds to step S2000. In this case, processing in and after step S2000 is performed.

In contrast, in a case where the CPU 101 determines in step S6000 that the end instruction has been issued (YES in step S6000), the series of processing illustrated in FIG. 6 ends.

In step S2000, the image acquisition unit 106 acquires data on an image corresponding to an imaging result of the camera module. This processing is substantially similar to the processing in the example described with reference to FIG. 2.

In step S6001, the GPU 105 initializes an index value i by setting the index value i to zero.

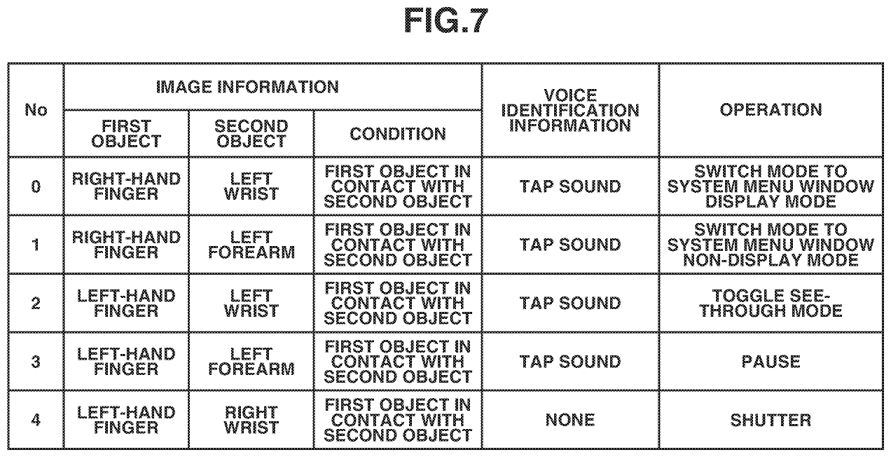

In step S6002, the GPU 105 acquires first object type information and second object type information from a combination list defining combinations of the first object and the second object detected from the image. The object type information is information indicating a type of the target object. For example, in a case where the target object is a body part, the object type information can include information indicating the body part such as a left wrist and a right-hand finger. The above-described combination list is separately described in detail below with reference to FIG. 7.

In step S6010, the GPU 105 detects a first object from an image indicated by the data acquired in step S2000.

In step S6020, the GPU 105 detects a second object from the image indicated by the data acquired in step S2000.

Then in step S2040, the GPU 105 determines whether the first object and the second object are in contact with each other.

In a case where the GPU 105 determines in step S2040 that the first object and the second object are in contact with each other (YES in step S2040), the processing proceeds to step S2050.

In contrast, in a case where the GPU 105 determines in step S2040 that the first object and the second object are not in contact with each other (NO in step S2040), the processing proceeds to step S6080.

In step S2050, the sound acquisition unit 107 acquires acoustic data corresponding to a collection result of sound around the information processing apparatus, as sound information.

In step S6060, the CPU 101 identifies the collected sound by performing analysis processing (e.g., acoustic analysis processing and voice recognition processing) on the sound information acquired in step S2050, thereby generating sound identification information indicating an identification result of the sound. In the present exemplary embodiment, the CPU 101 determines whether the sound indicated by the sound information is contact sound generated when a wrist is tapped with a finger. The contact sound is not limited to one type, and various sound may be included in the identification target. As a specific example, sound generated when a finger touches skin or sound generated when a finger touches clothes may be determined as the above-described contact sound.

In step S6070, the CPU 101 performs processing corresponding to a combination of the information on the analysis results of the motions of the first object and the second object and the sound identification information acquired in step S6060.

For example, FIG. 7 illustrates examples of processing performed corresponding to a combination of the information on the analysis results of the motions of the first object and the second object and the sound identification information, and the description particularly focuses on a case where operation of a system is performed.

More specifically, in a column of “image information”, two objects to be detected from the captured image and a condition determined by the motions of the two objects are defined. In columns of “first object” and “second object”, two objects to be detected (first object and second object) from the captured image are defined. In the present exemplary embodiment, “right-hand finger” and “left-hand finger” are to be detected as the first object, and “left wrist”, “left forearm”, and “right wrist” are to be detected as the second object. In a column of “condition”, the motions of objects to be detected is defined. In other words, in the example illustrated in FIG. 7, a detection result of a “contact” of any of “right-hand finger” and “left-hand finger” with any of “left wrist”, “left forearm”, and “right wrist” is used as one of triggers for operation of the system.

Further, in a column of “sound identification information”, sound used as the above-described sound identification information is defined. In the present exemplary embodiment, “tap sound” generated when the first object and the second object come into contact with each other is used as the sound identification information as one of the triggers for operation of the system.

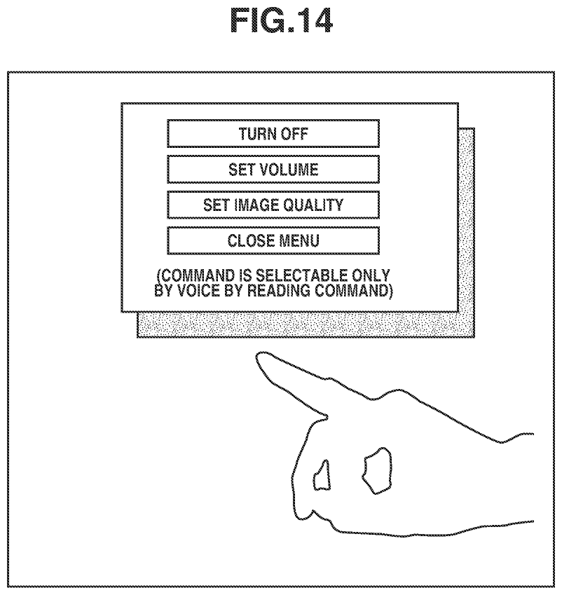

Subsequently, each operation defined in a column of “operation” is described. Operation defined as “switch mode to system menu window display mode” is operation of pausing the application under execution and displaying a system modal window. For example, FIG. 14 schematically illustrates a state where, as an example of the system modal window, a window displaying menu commands to receive an instruction for operation relating to the system, such as turn-off, is displayed in a virtual space.

In the example illustrated in FIG. 14, the user performs operation of the system by touching a menu command corresponding to desired operation among the menu commands displayed in the virtual space. At this time, the voice recognition result may not be used for recognition of the operation performed by the user. Further, as another example, the user may utter a menu command with voice, and the uttered menu command may be executed based on a recognition result of the voice. In this case, a recognition result of the operation of the object such as a touch operation may not be used for recognition of the operation performed by the user.

Operation defined as “switch mode to system menu window non-display mode” is operation of closing the opened menu window and resuming the paused application.

Operation defined as “toggle see-trough mode” is operation of switching a screen display state to “see-through mode”, or switching the screen display state from “see-through mode” to the original state. In other words, a display state other than “see-through mode” (the original state before switching) switches to “see-through mode”. The display state in “see-through mode” switches to the original state.

Operation defined as “shutter” is operation of storing currently-displayed VR scene data as a file. The data to be stored as a file is data on a target VR scene data that can be displayed as an image. Examples of the data to be stored as a file include three-dimensional (3D) data, an equidistant cylindrical image that enables reproduction of a scene at an angle of view of 180 degrees, and a perspective projection image of an area of interest.

Operation defined as “pause” is operation of pausing the operation of the application. In a case of no sound identification information, if it is determined that the first object and the second object are in contact with each other even though the sound information indicates silent or no sound or a sound that is not present in the list and thus not identified, the defined operation is performed.

Referring back to FIG. 6, in step S6080, the CPU 101 determines whether the processing in steps S6002 to S2040 has been performed on all of combinations of the first object and the second object defined in the combination list.

In a case where the CPU 101 determines in step S6080 that the processing in steps S6002 to S2040 has been performed on all of the combinations of the first object and the second object defined in the combination list (YES in step S6080), the processing returns to step S6000. In this case, the determination of an end instruction described as the processing in step S6000 is performed. In a case where the end instruction has not been issued, the processing in and after step S2000 is performed again.

In a case where the CPU 101 determines in step S6080 that the processing in steps S6002 to S2040 has not been performed on all of the combinations of the first object and the second object defined in the combination list (NO in step S6080), the processing proceeds to step S6090.

In step S6090, the CPU 101 increments the index value i. Further, the CPU 101 performs the processing in and after step S6002 again based on the incremented index value i. In the above-described manner, the detection is performed on each of the series of objects defined in the combination list by performing the loop of the processing in steps S6002 to S6090.

In the present exemplary embodiment, the case where the end instruction is issued based on the flow of processing illustrated in FIG. 6 is described; however, for example, in a case where depression of the power button provided in the main body is detected via the UI device connection unit 104, it is determined that the end instruction has been issued.

Further, in the present exemplary embodiment, various kinds of descriptions are given on the assumption that the menu window is a system modal window; however, the operation of the information processing apparatus according to the present exemplary embodiment is not limited thereto. As a specific example, the application can be operated at the same time, and the target window may not be the menu window. In other words, any configuration may be employed as long as the input mode may be switched by two triggers of object detection and sound identification (e.g., voice identification). Further, after the input mode is switched, operation can be performed by either one of the object detection and the sound identification. Further, in a case where operation is enabled only by a touch operation or in a case where operation is enabled only by sound such as voice along with the switching of the input mode, information is desirably displayed on a screen or the like so as to enable the user to identify the state.

As a third exemplary embodiment of the present disclosure, an example case where operation from the user is received while a moving image is displayed by using an application of a moving image player is described. In the present exemplary embodiment, a configuration and operation are described focusing on differences from the above-described first exemplary embodiment, and detailed descriptions of parts substantially similar to the above-described first exemplary embodiment are omitted.

First, an example of a configuration of an information processing apparatus according to the present exemplary embodiment is described with reference to FIG. 1B. A configuration illustrated in FIG. 1B is different from the configuration illustrated in FIG. 1A in that a distance information acquisition unit 109 is added.

The distance information acquisition unit 109 acquires a distance between the information processing apparatus (HMD) and each of the objects.

The distance information acquisition unit 109 may be realized by, for example, a time-of-flight (ToF) sensor, and may be configured to acquire a map in which depth measurement results are two-dimensionally arranged. The distance information acquisition unit 109 is located in the information processing apparatus such that an angle of view of the acquired two-dimensional map is substantially coincident with an angle of view of the image acquired by the image acquisition unit 106.

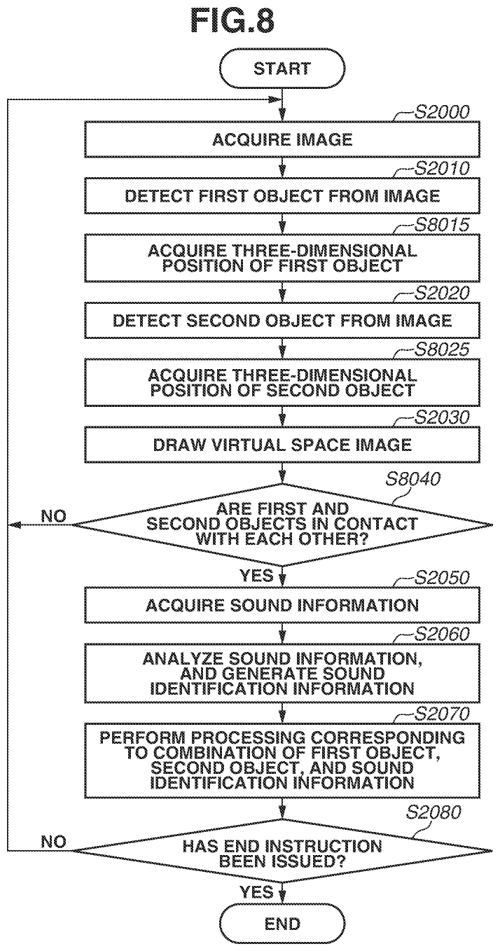

Next, an example of processing performed by the information processing apparatus according to the present exemplary embodiment is described with reference to FIG. 8.

In step S2000, the image acquisition unit 106 acquires data on an image corresponding to an imaging result of the camera module.

In step S2010, the GPU 105 detects a first object from the image indicated by the data acquired in step S2000.

In step S8015, the distance information acquisition unit 109 acquires a three-dimensional position of the first object. More specifically, the distance information acquisition unit 109 acquires the three-dimensional position of the first object by collating a two-dimensional position of the first object detected in step S2010 in the image with the two-dimensional depth map.

In step S2020, the GPU 105 detects a second object from the image indicated by the acquired data.

In step S8025, the distance information acquisition unit 109 acquires a three-dimensional position of the second object. More specifically, the distance information acquisition unit 109 acquires the three-dimensional position of the second object by collating a two-dimensional position of the second object detected in step S2020 in the image with the two-dimensional depth map.

In step S2030, the GPU 105 draws a virtual space image (e.g., CG), and displays the drawn image on the display panel connected to the GPU 105.

In step S8040, the GPU 105 determines whether the first object and the second object are in contact with each other.

In a case where the GPU 105 determines in step S8040 that the first object and the second object are in contact with each other (YES in step S8040), the processing proceeds to step S2050.

In contrast, in a case where the GPU 105 determines in step S8040 that the first object and the second object are not in contact with each other (NO in step S8040), the processing returns to step S2000. In this case, the processing in and after step S2000 is performed again.

The contact between the first object and the second object may be determined based on, for example, whether the first object and the second object are located close to each other (e.g., whether the distance therebetween is within three centimeters). In other words, the GPU 105 may determine whether the first object and the second object are in contact or not in contact with each other based on a change in the relative positional relationship of the first object and the second object.

The processing in and after step S2050 is substantially similar to the processing in the example described with reference to FIG. 2.

As described above, the information processing apparatus according to the present exemplary embodiment determines whether the two objects are in contact with each other based on proximity of the three-dimensional positions of the objects by using the three-dimensional information corresponding to the measurement result of the distance with each of the objects. As a result, an effect of further improving the accuracy of determination of the operation corresponding to each motions of the two objects can be expected. The positions of the two target objects may be corrected or estimated by using a detection result of an acceleration or a speed of each of the objects. As a result, for example, even under a situation where an obstacle is interposed between the target object to be subjected to the position detection and the camera module (or a ranging sensor), an effect of preventing deterioration in the accuracy of estimation of the positions of the objects can be expected.

In the present exemplary embodiment, the example where the ToF sensor is used as the ranging sensor is described; however, the configuration and the method to measure or estimate the distance between the information processing apparatus and each of the objects are not particularly limited as long as the distance between the information processing apparatus and each of the objects can be measured or estimated. As a specific example, a stereo camera module may be adopted as a device for ranging, and the distance between the information processing apparatus and each of the objects may be measured by a triangulation method using parallax of stereo images corresponding to an imaging result. As another example, a size of each object to be detected may be previously stored as information, and the distance between the information processing apparatus and the object may be estimated based on a size of each detected object.

Further, similar to the first exemplary embodiment, the case where the object is detected by using the image (e.g., RGB image) acquired from the camera module via the image acquisition unit 106 is described in the present exemplary embodiment. On the other hand, the configuration and the method for object detection are not particularly limited as long as the object can be detected. As a specific example, non-RGB image information like a map in which measurement results of the distance (depth) of the object acquired by the distance information acquisition unit 109 such as the ToF sensor are two-dimensionally arranged may be used for detection and recognition of the object.

In the present exemplary embodiment, the description has been given focusing on the operation of the application of a moving image player, and the example where the operation is realized by acquiring the three-dimensional positions of the objects is described. However, a target to which the operation method is applied is not limited only to the application. As a specific example, as in the above-described second exemplary embodiment, the method described in the present exemplary embodiment may be applied to operation of the system. As a specific example, operation relating to display of a system window or operation relating to switching of an input mode may be realized based on the method described in the present exemplary embodiment. In a case where the input mode is switched, information indicating that the input mode is switched is drawn in a part of the virtual space image by using characters or an icon, so that an effect of further improving user convenience can be expected.

As a fourth exemplary embodiment of the present disclosure, another example where operation from the user is received while a moving image is displayed by using the application of the moving image player is described. In the present exemplary embodiment, a configuration and operation are described focusing on differences from the above-described third exemplary embodiment, and detailed descriptions of parts substantially similar to the above-described third exemplary embodiment are omitted.

In the present exemplary embodiment, an example case where detection from image information is not performed with respect to at least some of a plurality of objects to be detected, and virtual objects present in a virtual space are used as the objects is described. In the following description, for convenience, a virtual object present in the virtual space is used as the second object. In this case, since the second object is the virtual object, a coordinate (i.e., positional information) of the virtual object is held as information used to display the virtual object. An information processing apparatus according to the present exemplary embodiment recognizes a position where the virtual object (e.g., second object) is to be located, by using the coordinate of the virtual object.

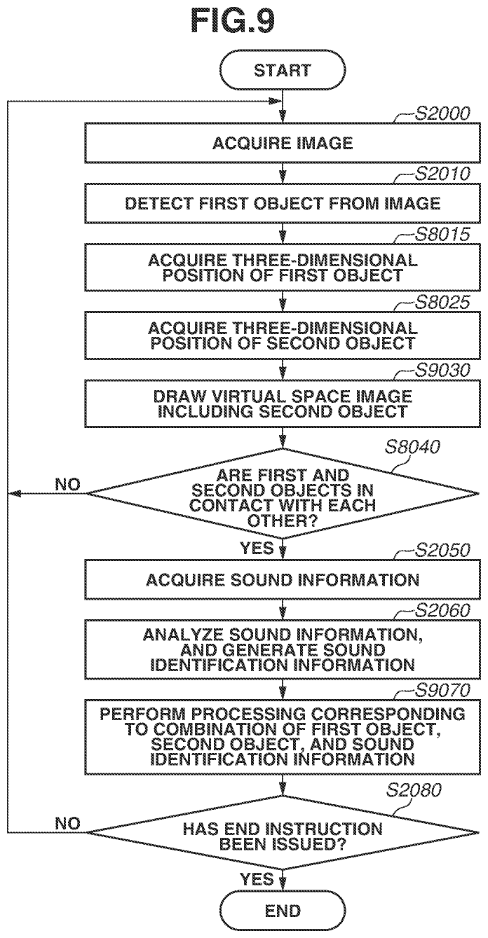

An example of processing performed by the information processing apparatus according to the present exemplary embodiment is described with reference to FIG. 9.

The example illustrated in FIG. 9 is different from the example illustrated in FIG. 8 in that the processing in step S2020 is eliminated, and the processing in step S2030 is replaced with processing in step S9030. Thus, in the following, the example illustrated in FIG. 9 is described mainly based on the differences from the example illustrated in FIG. 8.

In step S8025, the GPU 105 acquires a three-dimensional position of the second object. In the present exemplary embodiment, the second object is a virtual object imitating a button. Thus, for example, the GPU 105 may acquire the three-dimensional position of the second object based on a coordinate held as information to display the second object as the virtual object.

In step S9030, the GPU 105 draws a virtual space image including the second object, and displays the drawn image on the display panel connected to the GPU 105.

More specifically, the GPU 105 draws the virtual space image in which the second object as the virtual object imitating a button is disposed at the three-dimensional position acquired in step S8025.

In step S9070, the CPU 101 performs processing corresponding to a combination of the information on the analysis results of the motions of the first object and the second object (e.g., detection result of contact between the objects) and the sound identification information acquired in step S2060.

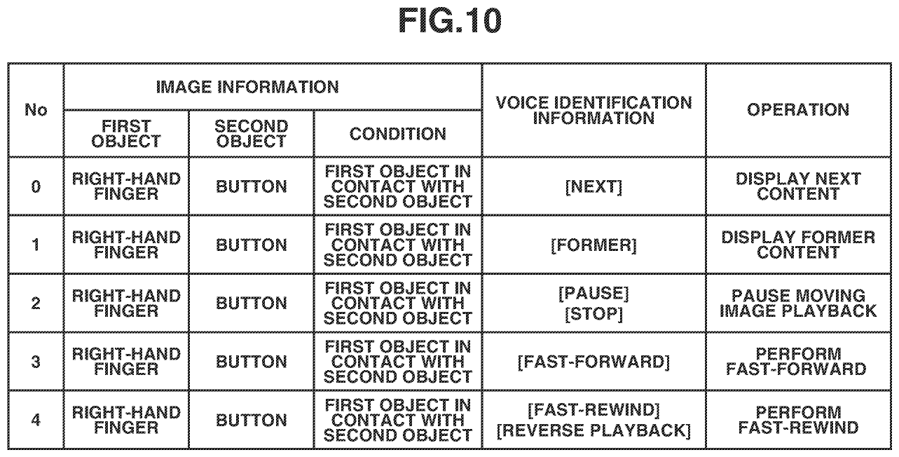

For example, FIG. 10 illustrates other examples of the processing performed corresponding to the combination of the information on the analysis results of the motions of the first object and the second object and the voice identification information particularly focusing on a case where a command for the moving image player is executed. The present exemplary embodiment is different from the third exemplary embodiment in that the second object is the virtual object imitating a button, and the other operation in the present exemplary embodiment is substantially similar to the third exemplary embodiment.

As described above, in the present exemplary embodiment, even in a case where one of the plurality of objects to be subjected to motion detection is an object that is physically present and the other object is a virtual object, it is possible to perform operation corresponding to the combination of the contact determination and the sound identification result.

In the present exemplary embodiment, the example case where the number of virtual objects is one is described; however, a plurality of virtual objects may be motion detection targets. As a specific example, a plurality of virtual objects (e.g., buttons) may be set as candidates of the second object, and operation to be performed may be determined based on which virtual object, among the plurality of virtual objects, is used as the target of the contact determination for determining contact with the first object. As a result, patterns of the combination of the first object and the second object as the contact determination target are increased, various types of operation can be set as execution targets.

The example case where the object imitating a button is adopted as the virtual object is described; however, the virtual object is not limited to an object imitating a button, and an object having another shape or an object of another type may be adopted. As a specific example, a semi-translucent cubic or spherical virtual floating object that does not exist in reality may be adopted. In such a case, for example, in a case where a body part such as a hand is inserted into the object, it may be determined that the part and the object are in contact with each other.

Further, in a case where VR is adopted, an object present in a real space is also drawn as a virtual object in the virtual space image in some cases. In such a case, a position and a motion of the object present in the real space corresponding to the drawn virtual object may be recognized based on a coordinate of the drawn virtual object. In other words, in such a case, both of the first object and the second object may be handled as the virtual objects, and motions of the objects (e.g., contact between the objects) may be detected and analyzed based on the coordinates of the respective objects.

In the present exemplary embodiment, the case where the identification result of the voice uttered by the user is used as the sound identification information is described; however, the sound is not limited to voice, and an identification result of another type of sound may be used. As a specific example, in a case where a finger snapping sound that is set as an identification target is detected, operation previously associated with the sound may be performed. Further, in a case where sound other than voice is set as an identification target, an effect of improving user convenience can be expected by drawing a guide object indicating which sound is associated with which operation in the virtual space image.

As a fifth exemplary embodiment of the present disclosure, another example case where operation from the user is received while a moving image is displayed by using an application of a moving image player is described. In the present exemplary embodiment, a configuration and operation are described focusing mainly on differences from the above-described first exemplary embodiment, and detailed descriptions of parts substantially similar to the above-described first exemplary embodiment are omitted.

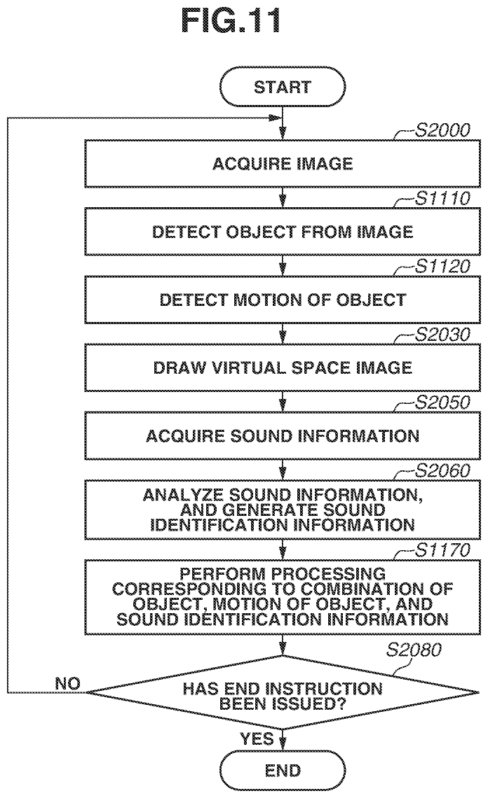

An example of processing performed by an information processing apparatus according to the present exemplary embodiment is described with reference to FIG. 11.

In step S2000, the image acquisition unit 106 acquires data on an image corresponding to an imaging result of the camera module.

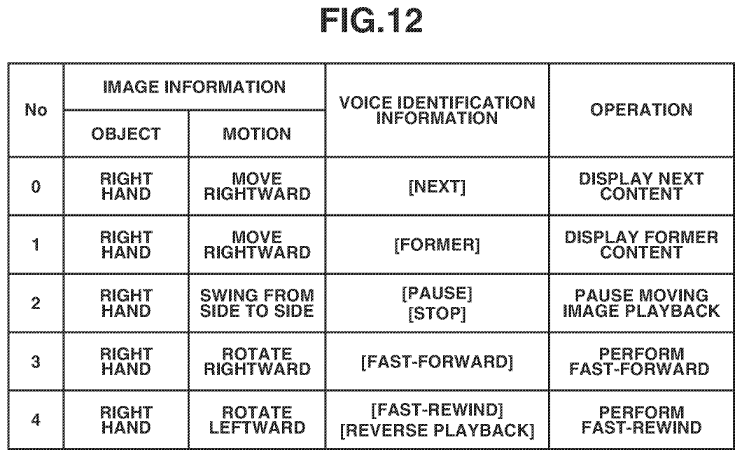

In step S1110, the GPU 105 detects an object from the image indicated by the data acquired in step S2000. Examples of the object to be detected are illustrated in a column of “object” in a table illustrated in FIG. 12. FIG. 12 is separately described in detail below.

In step S1120, the GPU 105 detects motion of the object by using a detection result of the object in step S1110. As a specific example, the GPU 105 may perform motion search on a target object based on a technique called block matching and acquire a motion vector of the object as a motion detection result of the object based on a result of the search. The motion search of the object by the block matching can be performed by using an existing technique, so that a detailed description thereof is omitted. For example, in a case where an image of 60 fps is acquired and motion vectors of the object for last three seconds are acquired, 180 motion vectors are acquired for the object.

The processing in steps S2030, S2050, and S2060 is similar to the processing in the example described with reference to FIG. 2. Thus, detailed descriptions of the processing are omitted.

In step S1170, the CPU 101 performs processing corresponding to a combination of the information on the analysis result of the motion of the object and the sound identification information acquired in step S2060.

For example, FIG. 12 illustrates examples of processing performed corresponding to a combination of the information on the analysis result of the motion of the object and the voice identification information, and the description particularly focuses on a case where a command for a moving image player is executed.

More specifically, in a column of “image information”, an object to be detected from the captured image and the motion of the object are defined.

In a column of “voice identification information”, uttered sounds to be used as the above-described sound identification information is defined.

In a column of “operation”, commands (i.e., processing to be performed) for the moving image player that are previously associated with respective combinations of “image information” and “voice identification information” are defined.

Referring back to FIG. 11, processing in and after step S2080 is similar to the processing in the example described with reference to FIG. 2. In other words, it is determined whether an end instruction has been issued, and in a case where it is determined that an end instruction has been issued, the series of processing illustrated in FIG. 11 ends.

In a case where either one of the analysis result of the motion of the object and the identification result of the sound such as voice is used for recognition of the operation performed by the user, normal conversation and gestures are erroneously recognized as the operation performed by the user even though the operation is unintended by the user in some cases. In contrast, in the method according to the present exemplary embodiment, both of the analysis result of the motion of the object and the identification result of the sound such as voice are used for recognition of the operation performed by the user. This makes it possible to suppress occurrence of erroneous operation as compared to a case where only either one of the analysis result of the motion of the object and the identification result of the sound such as voice is used for recognition of the operation performed by the user.

### Other Exemplary Embodiments

The present disclosure can be realized by the process of supplying a program for realizing one or more functions of the above-described exemplary embodiments to a system or an apparatus through a network or a recording medium and causing one or more processors in a computer of the system or the apparatus to read out and execute the program. Further, the present disclosure can be realized by a circuit (e.g., application specific integrated circuit (ASIC)) for realizing one or more functions.

According to the exemplary embodiments of the present disclosure, it is possible to further suppress occurrence of erroneous recognition of operation under a situation where recognition results of the motions of objects are used for operation.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-149348, filed Sep. 14, 2021, which is hereby incorporated by reference herein in its entirety.

What is claimed is:

1. An information processing apparatus, comprising:
at least one memory storing instructions; and
at least one processor that, upon execution of the instructions, is configured to operate as:
a motion analysis unit configured to analyze a motion of an object in a moving image;
a sound identification unit configured to identify detected sound by analyzing the detected sound while playing the moving image; and
a control unit configured to perform processing corresponding to a combination of motion information including an analysis result of the motion of the object and sound identification information including an identification result of the sound.

2. The information processing apparatus according to claim 1,
wherein the motion analysis unit acquires information indicating a change in a relative positional relationship of a plurality of objects from the analysis result of the motion of the object, and
wherein the control unit performs processing corresponding to a combination of the motion information including the information indicating the change in the relative positional relationship of the objects and the sound identification information.

3. The information processing apparatus according to claim 1,
wherein the motion analysis unit acquires information indicating whether a plurality of objects are in contact with each other from the analysis result of the motion of the object, and
wherein the control unit performs processing corresponding to a combination of the motion information including the information indicating whether the plurality of objects are in contact with each other and the sound identification information.

4. The information processing apparatus according to claim 3, wherein the motion analysis unit determines whether the plurality of objects are in contact with each other, based on proximity of three-dimensional positions of the objects in a real space.

5. The information processing apparatus according to claim 3, wherein at least some of the plurality of objects are virtual objects set in a virtual space.

6. The information processing apparatus according to claim 1, further comprising an object identification unit configured to identify the object,
wherein the control unit performs processing corresponding to a combination of object identification information including an identification result of the object, the motion information and the sound identification information.

7. The information processing apparatus according to claim 1,
wherein the sound identification unit identifies a contact sound generated by a plurality of objects from the detected sound, and
wherein the control unit performs processing corresponding to a combination of the motion information and the sound identification information including an identification result of the contact sound generated by the plurality of objects.

8. The information processing apparatus according to claim 1,
wherein the sound identification unit recognizes sound information on a word uttered as voice, and
wherein the control unit performs processing corresponding to a combination of the motion information and the sound identification information including a recognition result of the sound information on the word.

9. The information processing apparatus according to claim 1, further comprising a data acquisition unit configured to acquire data including information on the object,
wherein the motion analysis unit analyzes the motion of the object from the data.

10. The information processing apparatus according to claim 9,
wherein the data is data on the image obtained by imaging in a direction in which a line of sight of a user is directed from a head of the user, and
wherein the motion analysis unit analyzes the motion of the object by detecting the object captured in the image.

11. The information processing apparatus according to claim 10,
wherein the information processing apparatus is a head-mounted display (HMD)-type information processing terminal that is to be mounted on the head of the user, and
wherein the data on the image is data on an image captured by an imaging apparatus supported by a housing of the information processing terminal and corresponding to an imaging result in the direction in which the line of sight of the user is directed.

12. The information processing apparatus according to claim 1, further comprising a positional information acquisition unit configured to acquire positional information on the object,
wherein the motion analysis unit analyzes a change in the positional information on the object, and
wherein the control unit performs processing corresponding to a combination of the motion information including an analysis result of the change in the positional information on the object and the sound identification information.

13. The information processing apparatus according to claim 1,
wherein, in a case where the object is a body part, the motion analysis unit analyzes a motion of the body part, and
wherein the control unit performs processing corresponding to a combination of the motion information including an analysis result of the motion of the body part and the sound identification information.

14. The information processing apparatus according to claim 1, further comprising a display unit configured to cause a display device to display a detection result of the object combined with computer graphics (CG).

15. The information processing apparatus according to claim 1,
wherein the sound identification unit recognizes voice uttered by a user and identifies the user based on a recognition result of the voice, and
wherein the control unit excludes voice uttered by a user other than a target user, from a target to be used as the sound identification information.

16. An information processing method performed by an information processing apparatus, the information processing method comprising:
analyzing a motion of an object in a moving image;
identifying detected sound by analyzing the detected sound while playing the moving image; and
performing processing corresponding to a combination of motion information including an analysis result of the motion of the object and sound identification information including an identification result of the sound.

17. A non-transitory computer-readable storage medium storing instructions that, when executed by a computer, cause the computer to perform a method comprising:
analyzing a motion of an object in a moving image;
identifying detected sound by analyzing the detected sound while playing the moving image; and
performing processing corresponding to a combination of motion information including an analysis result of the motion of the object and sound identification information including an identification result of the sound.
